(19) United States
(12) Patent Application Publication
(10) Pub. No.: US 2017/0134598 A1
(43) Pub. Date: May 11, 2017

(54) IMAGE FORMING APPARATUS INCORPORATING AUTOMATIC COUPLING DEVICE

(71) Applicants: Tatsuaki NAGANO, Kanagawa (JP); Yasunobu YOUDA, Kanagawa (JP); Yohei OSANAI, Kanagawa (JP); Satoshi NARAI, Kanagawa (JP); Toshiyuki HORIKAWA, Kanagawa (JP); Takuji KAWAI, Kanagawa (JP); Daisuke IMAKI, Tokyo (JP); Takayuki ANDOH, Kanagawa (JP); Susumu MIYAZAKI, Tokyo (JP); Yuki FUJII, Kanagawa (JP); Koichi ONO, Kanagawa (JP); Takeshi SHIKAMA, Kanagawa (JP); Hiroaki IKEDA, Tokyo (JP); Shingo SHIRAMURA, Kanagawa (JP); Hideo TANAKA, Kanagawa (JP); Tetsuo INUI, Kanagawa (JP)

(72) Inventors: Tatsuaki NAGANO, Kanagawa (JP); Yasunobu YOUDA, Kanagawa (JP); Yohei OSANAI, Kanagawa (JP); Satoshi NARAI, Kanagawa (JP); Toshiyuki HORIKAWA, Kanagawa (JP); Takuji KAWAI, Kanagawa (JP); Daisuke IMAKI, Tokyo (JP); Takayuki ANDOH, Kanagawa (JP); Susumu MIYAZAKI, Tokyo (JP); Yuki FUJII, Kanagawa (JP); Koichi ONO, Kanagawa (JP); Takeshi SHIKAMA, Kanagawa (JP); Hiroaki IKEDA, Tokyo (JP); Shingo SHIRAMURA, Kanagawa (JP); Hideo TANAKA, Kanagawa (JP); Tetsuo INUI, Kanagawa (JP)

(73) Assignee: Ricoh Company, Ltd., Tokyo (JP)

(21) Appl. No.: 15/347,179

(22) Filed: Nov. 9, 2016

(30) Foreign Application Priority Data
Nov. 10, 2015 (JP) 2015-220632
Nov. 2, 2016 (JP) 2016-214953

(51) Int. Cl. H04N 1/00; G03G 15/00

(52) U.S. Cl. CPC H04N 1/00559; H04N 1/0032; H04N 1/00525; H04N 1/00554; H04N 1/00795; G03G 15/6529; H04N 2201/0094

(57) ABSTRACT

An image forming apparatus includes a housing, an image forming device, an image reading device coupled with the housing via a first hinge and switchable between an overlapping state and a standing state, the image reading device configured to read an image on an original document, an automatic document feeder coupled with the image reading device via a second hinge and switchable between an overlapping state overlapping the image reading device and a standing state standing at the image reading device, the automatic document feeder configured to turn the original document and convey the original document to an image position, and an automatic coupling device to couple the automatic document feeder and the image reading device when the image reading device is opened while the automatic document feeder is overlapped on the image reading device.

### CROSS-REFERENCE TO RELATED APPLICATIONS

This patent application is based on and claims priority pursuant to 35 U.S.C. §119(a) to Japanese Patent Application Nos. 2015-220632, filed on Nov. 10, 2015, and 2016-214953, filed on Nov. 2, 2016, in the Japan Patent Office, the entire disclosures of each of which are hereby incorporated by reference herein.

### BACKGROUND

Technical Field

This disclosure relates to an image forming apparatus that corresponds to a multi-functional apparatus including at least two functions of a copier, facsimile machine, printer, and printing machine.

Related Art

A widely used image forming apparatus such as a multifunction printer includes an image forming device, an image reading device such as a scanner, and an automatic document feeder (ADF). The image reading device is mounted on the image forming device and the ADF is mounted on the image reading device.

An example configuration of an image forming apparatus includes a housing that accommodates an image forming device. The housing has an opening on a top face, where a cover (e.g., a recording sheet output tray) closes the open top face. An image reading device is disposed overlapping on the top face of the housing (i.e., the top face of the image forming device), and an automatic document feeder is disposed overlapping on the image reading device. In the image forming apparatus, the image reading device is turns upwardly toward a back side of the image forming apparatus. Consequently, the automatic document feeder mounted on the image reading device and the cover make an upward turn toward the back side of the image forming apparatus together simultaneously. By so doing, the top face of the image forming device opens, so that replacement of toner bottle(s) and other maintenance can be performed.

In this image forming apparatus, when the image reading device is rotated upwardly to open with great force, it is likely that the automatic document feeder is turned further backwards from the image reading device. In addition, the weight of the automatic document feeder is heavier at a U-turn side, and therefore the center of gravity of the automatic document feeder is located at the U-turn side. Accordingly, when the automatic document feeder is further rotated toward the back side of the image forming apparatus, the image forming apparatus is likely to fall backwardly.

In order to address this inconvenience, there are known image forming apparatuses that include a coupling locking device. The coupling locking device locks the image reading device and the cover to cause the image reading device that is locked to the cover to open together with the cover, so that toner bottle(s) can be replaced more easily.

With the coupling locking device, a known an image forming apparatus achieves a switching operation of coupling and uncoupling an automatic document feeder and an image reading device and another switching operation of coupling and uncoupling the image reading device and a cover. That is, a user performs respective switching operations of coupling and uncoupling the automatic document feeder, the image reading device, and the cover.

### SUMMARY

At least one aspect of this disclosure provides an image forming apparatus including a housing, an image forming device, an image reading device, an automatic document feeder, and an automatic coupling device. The image forming device is housed in the housing. The image reading device is coupled with the housing at a rear end of the housing via a first hinge and switchable between an overlapping state overlapping the housing and a standing state standing at the rear end of the housing. The image reading device is configured to read an image on an original document. The automatic document feeder is coupled with the image reading device at a rear end of the image reading device via a second hinge and switchable between an overlapping state overlapping the image reading device and a standing state standing at the rear end of the image reading device. The automatic document feeder is configured to turn the original document and convey the original document to an image position. The automatic coupling device is disposed across the image reading device and the automatic document feeder and configured to couple the automatic document feeder and the image reading device with each other when the image reading device is opened in a state in which the automatic document feeder is overlapped on the image reading device.

### BRIEF DESCRIPTION OF THE SEVERAL VIEWS OF THE DRAWINGS

FIG. 1 is a schematic front view illustrating an image forming apparatus according to an embodiment of this disclosure;

FIG. 2 is a detailed front view illustrating the image forming apparatus of FIG. 1;

FIG. 3A is a schematic longitudinal sectional cross section along a front view direction of an image reading device according to an embodiment of this disclosure, the image reading device being included in the image forming apparatus of FIG. 1 in a flatbed scanner mode;

FIG. 3B is a schematic longitudinal sectional cross section along a front view direction of the image reading device while a single unit optical scanning unit is moving when the mode is switched;

FIG. 3C is a schematic longitudinal sectional cross section along a front view direction of the image reading device in a DF scanner mode;

FIG. 4 is a schematic plan view illustrating the image forming apparatus according to an embodiment of this disclosure;

FIG. 5 is a schematic front view illustrating the image reading device in the DF scanner mode;

FIG. 6 is a schematic front view illustrating the image reading device in the flatbed scanner mode;

FIG. 7 is a schematic perspective view illustrating an automatic document feeder according to an embodiment of this disclosure;

FIG. 8 is a block diagram illustrating an ADF controller and an apparatus controller and parts connected to the ADF controller of the image forming apparatus of FIG. 1;

FIG. 9 is a schematic side view illustrating the image forming apparatus according to an embodiment of this disclosure;

FIG. 10 is a schematic side view illustrating the image forming apparatus according to an embodiment of this disclosure in a state in which the automatic document feeder, the image reading device, and a recording sheet output tray are open at a relatively small angle with respect to a housing of the image forming apparatus; and

FIG. 11 is a schematic side view illustrating the image forming apparatus according to an embodiment of this disclosure in a state in which the automatic document feeder, the image reading device, and the recording sheet output tray are open at an angle of approximately 90 degrees with respect to the housing of the image forming apparatus.

### DETAILED DESCRIPTION

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

The terminology used herein is for describing particular embodiments and examples and is not intended to be limiting of exemplary embodiments of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of an image forming apparatus according to exemplary embodiments of this disclosure. Elements having the same functions and shapes are denoted by the same reference numerals throughout the specification and redundant descriptions are omitted. Elements that do not demand descriptions may be omitted from the drawings as a matter of convenience. Reference numerals of elements extracted from the patent publications are in parentheses so as to be distinguished from those of exemplary embodiments of this disclosure.

This disclosure is applicable to any image forming apparatus, and is implemented in the most effective manner in an electrophotographic image forming apparatus.

In describing preferred embodiments illustrated in the drawings, specific terminology is employed for the sake of clarity. However, the disclosure of this disclosure is not intended to be limited to the specific terminology so selected and it is to be understood that each specific element includes any and all technical equivalents that have the same function, operate in a similar manner, and achieve a similar result.

Referring now to the drawings, wherein like reference numerals designate identical or corresponding parts throughout the several views, preferred embodiments of this disclosure are described.

Descriptions are given of an embodiment applicable to an image forming apparatus, with reference to the following figures.

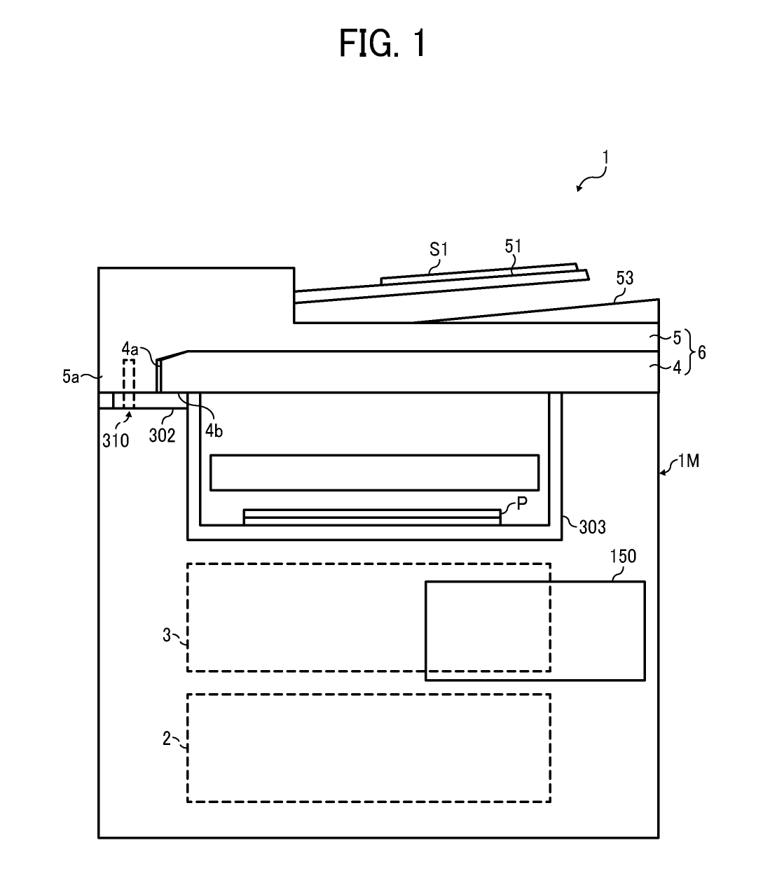

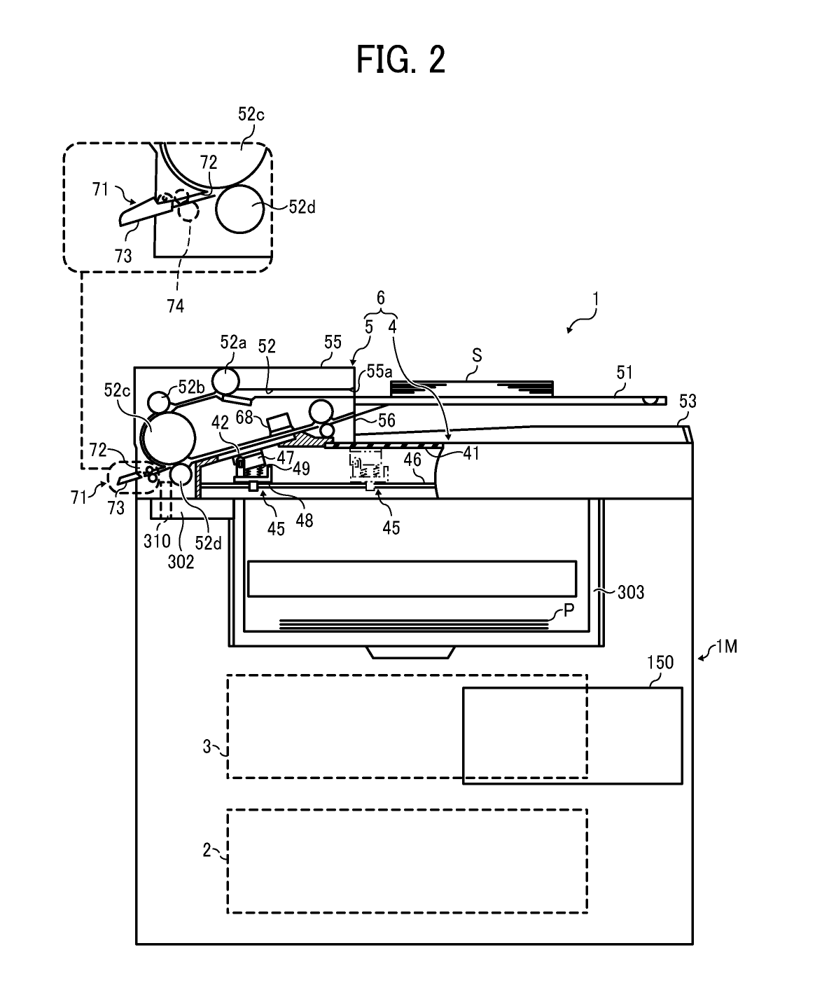

FIG. 1 is a schematic front view illustrating an image forming apparatus 1 according to an embodiment of this disclosure. FIG. 2 is a detailed front view illustrating the image forming apparatus 1 of FIG. 1.

It is to be noted that identical parts are given identical reference numerals and redundant descriptions are summarized or omitted accordingly.

The image forming apparatus 1 may be a copier, a facsimile machine, a printer, a multifunction peripheral or a multifunction printer (MFP) having at least one of copying, printing, scanning, facsimile, and plotter functions, or the like. According to the present example, the image forming apparatus 1 is an electrophotographic copier that forms toner images on recording media by electrophotography.

It is to be noted in the following examples that: the term “image forming apparatus” indicates an apparatus in which an image is formed on a recording medium such as paper, OHP (overhead projector) transparencies, OHP film sheet, thread, fiber, fabric, leather, metal, plastic, glass, wood, and/or ceramic by attracting developer or ink thereto; the term “image formation” indicates an action for providing (i.e., printing) not only an image having meanings such as texts and figures on a recording medium but also an image having no meaning such as patterns on a recording medium; and the term “sheet” is not limited to indicate a paper material but also includes the above-described plastic material (e.g., an OHP sheet), a fabric sheet and so forth, and is used to which the developer or ink is attracted. In addition, the “sheet” is not limited to a flexible sheet but is applicable to a rigid plate-shaped sheet and a relatively thick sheet.

Further, size (dimension), material, shape, and relative positions used to describe each of the components and units are examples, and the scope of this disclosure is not limited thereto unless otherwise specified.

Further, it is to be noted in the following examples that: the term “sheet conveying direction” indicates a direction in which a recording medium travels from an upstream side of a sheet conveying path to a downstream side thereof; the term “width direction” indicates a direction basically perpendicular to the sheet conveying direction.

As illustrated in FIGS. 1 and 2, the image forming apparatus 1 is a digital multifunction printer that includes a housing 1M, a recording sheet output tray 303, an image reading device (scanner) 4, an automatic document feeder (ADF) 5, and an automatic coupling device 310. The housing 1M includes a sheet feeding device 2, an image forming device 3, and an instruction input unit 150. The instruction input unit 150 is mounted on an outer front face of the image forming apparatus 1 to receive instructions from a user. The recording sheet output tray 303 functions as a cover and a recording medium output tray to open and close an opening portion of an upper face of the housing 1M. The image reading device 4 is disposed overlapping the recording sheet output tray 303. The ADF 5 is disposed overlapping the image reading device 4. The automatic coupling device 310 couples the ADF 5, the image reading device 4, and the recording sheet output tray 303. The image reading device 4 and the ADF 5 form an image reader 6.

When an original document is read by the image reading device 4 in a flatbed scanner mode, the ADF 5 is turned upwardly to open the image reading device 4. At this time, the automatic coupling device 310 does not operate and the opening portion of the upper face of the housing 1M is opened. As the ADF 5 and the image reading device 4 are opened together while overlapping each other with respect to the housing 1M, the recording sheet output tray 303 becomes open. At this time, the automatic coupling device 310 automatically operates to couple the ADF 5, the image reading device 4, and the recording sheet output tray 303. Accordingly, even when being flung open, the ADF 5, the image reading device 4, and the recording sheet output tray 303 are designed to open by an angle sufficient for a user to remove consumable supplies such as a photoconductor and a toner bottle, preferably to open at an angle of approximately 90 degrees in a state in which the ADF 5, the image reading device 4, and the recording sheet output tray 303 are overlapping each other.

A detailed description is given of the operations performed in the image forming apparatus 1 according to the present embodiment of this disclosure.

Now, a description is given of operations of the image forming device 3 in the housing 1M of the image forming apparatus 1.

The image forming device 3 includes multiple photoconductor drums, respective developing devices, a transfer device including a transfer belt and a secondary transfer body, and a fixing device. The developing devices develop toner images by supplying respective colors of cyan (C), magenta (M), yellow (Y), and black (K). Based on image data obtained by the image reader 6 or an external computer, a laser light beam is emitted from, for example, an exposure device to a charged surface of each photoconductor drum, so s to form an electrostatic latent image on the surface of the photoconductor drum. Then, each developing device supplies toner onto the electrostatic latent image formed on the surface of each photoconductor drum, thus developing (visualizing) the electrostatic latent image into a visible toner image. Further, the image forming device 3 causes the visible toner image formed on the photoconductor drums to be primarily transferred onto the transfer belt. Then, the toner image is secondarily transferred onto a recording sheet that is fed from the sheet feeding device 2. Thereafter, the fixing device fixes the toner image to the recording sheet by application of heat and pressure to form a color image.

Now, a description is given of operations of the image reader 6 that includes the ADF 5 and the image reading device 4.

The image reader 6 performs an image reading operation by switching between a DF scanner mode and a flatbed scanner mode. The DF scanner mode is a mobile original document reading mode that employs a sheet through method in which an image formed on a mobile original document S1 is read while the mobile original document S1 is conveyed automatically by the ADF 5. The flatbed scanner mode is a stationary original document reading mode in which the stationary original document S2 is set on a flat exposure glass to read an image formed on the stationary original document S2 after the ADF 5 is closed. Further, the DF scanner mode includes a single side scanning mode and a duplex scanning mode, so that one of the single side scanning mode and the duplex scanning mode can be further selected.

When an image formed on the mobile original document S1 set on an original document table 51 in the DF scanner mode and the single scanning mode, the mobile original document S1 is picked up by a sheet feeding member disposed on an upper side of a leading end of the original document table 51 in a sheet entering direction, and is fed to an original document conveying passage 52. After making a U-turn at a document conveying roller 52c, the mobile original document S1 is further conveyed onto a DF exposure glass 42. While the mobile original document S1 is moving on the DF exposure glass 42, the image formed on a face down side of the mobile original document S1 is read by a first scanning unit 45 that is disposed below the DF exposure glass 42.

Further, when reading an image formed on a hard sheet H that is inserted from an opposite side to a sheet feeding direction from the original document table 51 in the DF scanner mode and the single side scanning mode, the image formed on a face down side of the hard sheet H is read by the first scanning unit 45 while the hard sheet H is moving on the DF exposure glass 42.

Further, in the DF scanner mode and the duplex scanning mode, the image formed on the mobile original document S1 or the hard sheet H is read in the single side scanning mode while being fed to the DF exposure glass 42. At the same time, the image formed on a face up side of the mobile original document S1 or the hard sheet H is also read by a second scanning unit 68 that is disposed at a downstream side of the DF exposure glass 42.

Further, in the flatbed scanner mode, after rotating the ADF 5 to open in a substantially upright state, a stationary original document S2 is set on the flatbed exposure glass 41 of the image forming device 3 and the ADF 5 is closed to be placed on the image forming device 3. Then, the first scanning unit 45 that scans the lower side of the flatbed exposure glass 41 reads the image formed on the face down side of the stationary original document S2.

Now, a further description is given of the configurations and functions of the image reading device 4 and the ADF 5.

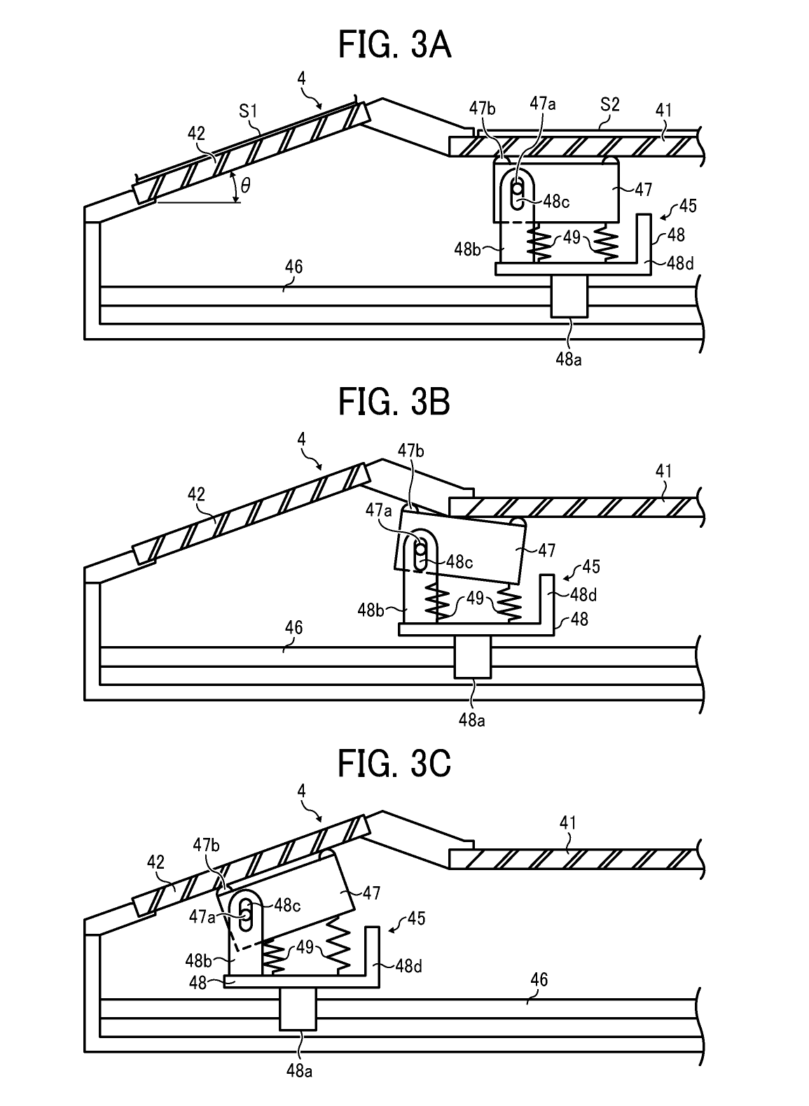

FIG. 2 is a detailed front view illustrating the image forming apparatus 1 of FIG. 1. FIG. 3A is a schematic longitudinal sectional cross section along a front view direction of the image reading device 4 in the flatbed scanner mode. The image reading device 4 is included in the image forming apparatus 1 of FIG. 1. FIG. 3B is a schematic longitudinal sectional cross section along the front view direction of the image reading device 4 while a single unit optical scanning unit 47 is moving when the mode is switched. FIG. 3C is a schematic longitudinal sectional cross section along the front view direction of the image reading device 4 in the DF scanner mode.

As illustrated in FIGS. 2, 3A, 3B, and 3C, the image reading device 4 includes the DF exposure glass 42 and the flatbed exposure glass 41. The flatbed exposure glass 41 is arranged horizontally. By contrast, the DF exposure glass 42 is tilted at a predetermined angle of inclination θ.

The image reading device 4 includes the first scanning unit 45 and a guide rod 46 that extends in a horizontal direction, that is, a left-and-right direction in FIGS. 3A through 3C. The first scanning unit 45 includes a single unit optical scanning unit 47, a bracket 48, and multiple compression coil springs (elastic members) 49. The bracket 48 supports the single unit optical scanning unit 47. The multiple compression coil springs 49 are assembled in a compressed state between the single unit optical scanning unit 47 and the bracket 48.

The single unit optical scanning unit 47 functions as a contact image sensor that includes, for example, a mold frame and optical components such as a unity magnification imaging device roof mirror lens array, a light path separation mirror, a unity magnification image sensor, and an illumination light source. The main scanning direction of the single unit optical scanning unit 47 is a vertical direction on the drawing sheet of FIG. 3.

The single unit optical scanning unit 47 has a large focal depth that can be applied to image reading of book type original documents. The single unit optical scanning unit 47 can perform line scanning with high resolution so as to read both an image formed on the stationary original document S2 placed on the flatbed exposure glass 41 and an image formed on the mobile original document S1 loaded on the DF exposure glass 42 in an inclined manner. It is to be noted that the single unit optical scanning unit 47 is not limited to a specific configuration but can have any configuration that is applicable to the DF scanner mode and the flatbed scanner mode.

The bracket 48 includes a lower slider portion 48a, a pair of retaining arms 48b, a slot 48c, and a bracket body 48d. The lower slider portion 48a is supported by the guide rod 46 and guided in a sub-scanning direction of the image forming apparatus 1. The pair of retaining arms 48b holds and retains the single unit optical scanning unit 47 at both sides in a main scanning direction of the image forming apparatus 1. The lower slider portion 48a and the pair of retaining arms 48b are attached to the bracket body 48d as a single unit.

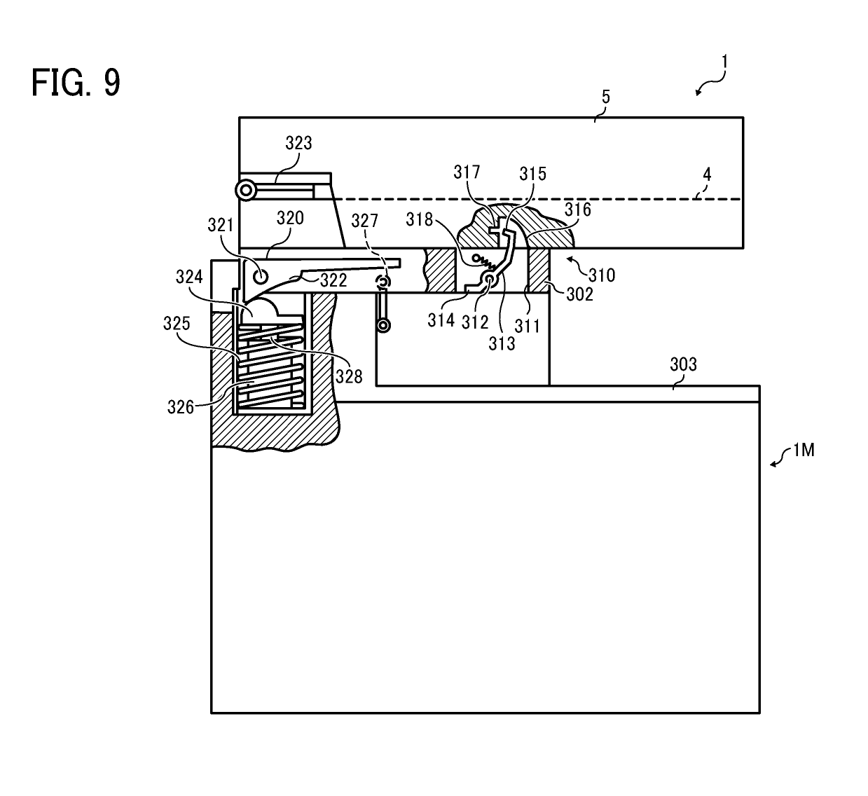

The bracket 48 is fixed at a portion of an endless timing belt that is spanned with taut around multiple timing pulleys. When a scan motor 103 (see FIG. 9) rotates one of the multiple timing pulleys, the bracket 48 is guided by the guide rod 46 to move in the sub-scanning direction.

The lower slider portion 48a has a cylindrical body fixed to a lower face of the bracket body 48d at the center in a longitudinal direction of the bracket body 48d.

Further, the pair of retaining arms 48b is a pair of plates that projects upwardly at both ends in the main scanning direction of the bracket body 48d.

The single unit optical scanning unit 47 includes a pivot shaft portion 47a that projects vertically from both end faces in the main scanning direction. The pair of retaining arms 48b includes the slot (oval) opening 48c extending in a vertical direction, so as to hold the pivot shaft portion 47a to be variable in position in an axial direction and in a vertical direction.

The multiple compression coil springs 49 presses the lower face of the single unit optical scanning unit 47 upwardly at multiple portions in the main scanning direction of the image forming apparatus 1 at a side of the flatbed exposure glass 41 and a side of the DF exposure glass 42.

Further, an upper slider portion 47b is attached to an upper face of the single unit optical scanning unit 47. The upper slider portion 47b is guided by the guide rod 46 and smoothly slides in the sub scanning direction while contacting the lower face of at least one of the flatbed exposure glass 41 and the DF exposure glass 42.

It is to be noted that the upper slider portion 47b may include multiple hemispherical projections or a rectangular ring shaped body. Alternatively, the upper slider portion 47b may be projections that extend in a longitudinal direction or a lateral direction of the single unit optical scanning unit 47 and separate from each other in a direction perpendicular to the longitudinal direction or the lateral direction. In any of the above-described configurations, it is preferable that the upper slider portion 47b includes a material that can smoothly move on the lower face of the flatbed exposure glass 41 and the lower face of the DF exposure glass 42 or other guiding surface with low frictional coefficient without lubrication.

As illustrated in FIGS. 3A, 3B, and 3C, the first scanning unit 45 can move in the sub-scanning direction so as to be located at a lower side of the flatbed exposure glass 41 and a lower side of the DF exposure glass 42. According to the position in the sub-scanning direction, the first scanning 45 can cause the single unit optical scanning unit 47 to move between a first scanning position and a second scanning position. The first scanning position is a horizontal position to read an image formed on the stationary original document S2 placed on the flatbed exposure glass 41. The second scanning position is an inclined position to read an image formed on the mobile original document S1 fed onto the DF exposure glass 42.

To be more specific, the single unit optical scanning unit 47 that is disposed below the flatbed exposure glass 41 and the DF exposure glass 42 slidably contacts one of the flatbed exposure glass 41 and the DF exposure glass 42 according to the position of the single unit optical scanning unit 47 in the sub-scanning direction. Accordingly, the single unit optical scanning unit 47 is regulated in the tilt about the pivot shaft portion 47a while being freely movable along the guide rod 46 in the sub-scanning direction.

It is to be noted that the single unit optical scanning unit 47 may have a longer length so as to contact both the flatbed exposure glass 41 and the DF exposure glass 42 when the single unit optical scanning unit 47 is located at a position illustrated in FIG. 3B.

The first scanning unit 45 including the single unit optical scanning unit 47 perform line scanning of an image formed on the lower face of the stationary original document S2 placed on the flatbed exposure glass 41 and moves in the sub-scanning direction simultaneously. By so doing, the first scanning unit 45 scans the flat area to read the image of the stationary original document S2. In addition, the first scanning unit 45 repeats line scanning of an image formed on the lower face of the mobile original document S1 passing on the DF exposure glass 42. By so doing, the first scanning unit 45 scans the flat area to read the image of the mobile original document S1.

When reading an image in the flatbed scanner mode, the first scanning unit 45 moves from a flatbed scanning home position that is depicted by a solid line in FIG. 3A in the sub-scanning direction toward a far side of the flatbed exposure glass 41 separating from the flatbed scanning home position (i.e., toward a right side direction in FIG. 3A). Then, as the first scanning unit 45 moves within a minute range in the main scanning direction that is a direction perpendicular to the sub-scanning direction, the single unit optical scanning unit 47 performs line scanning of the image on the stationary original document S2. After the line scanning is finished, the first scanning unit 45 returns to the flatbed scanning home position.

When reading an image in the DF scanner mode, the first scanning unit 45 moves from a DF scanning home position that is depicted by a solid line in FIG. 3C toward a downward side of inclination of the DF exposure glass 42, the single unit optical scanning unit 47 separating from the DF scanning home position. Then, the first scanning unit 45 stops at a scanning position (specific operation performing position) Pd1 to read the image on the mobile original document S1 passing over the DF exposure glass 42.

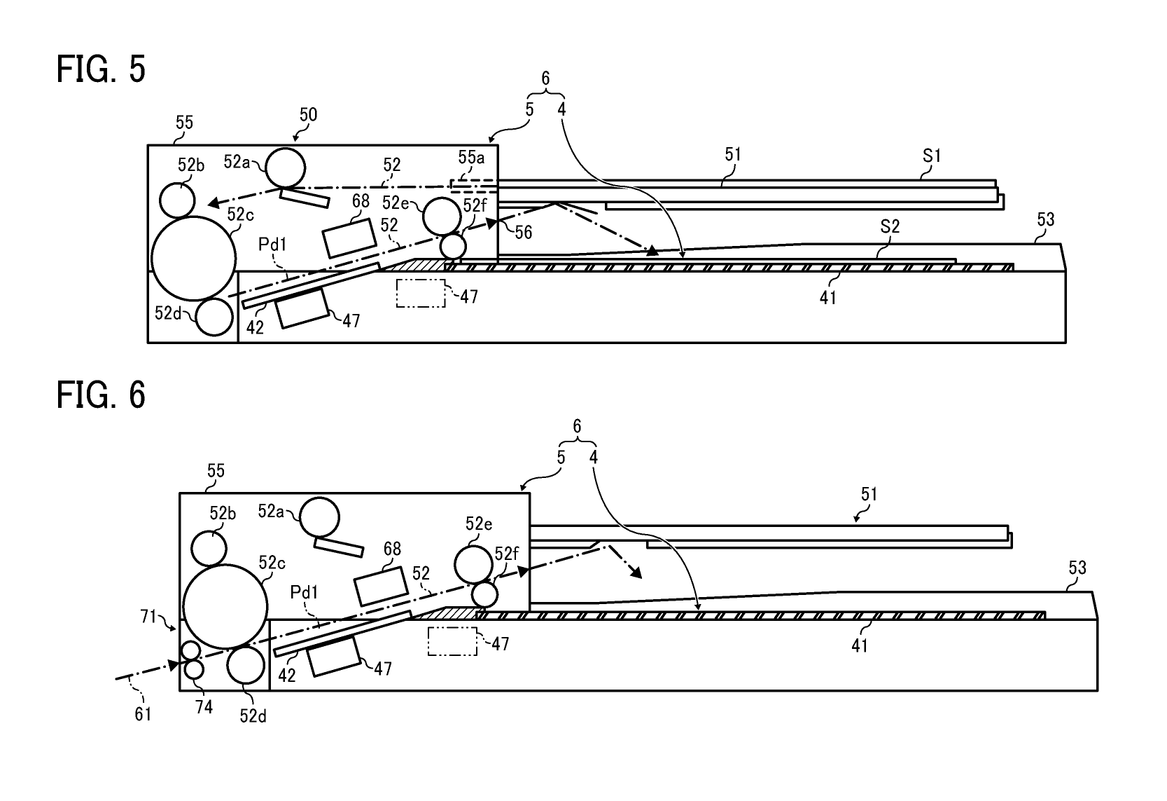

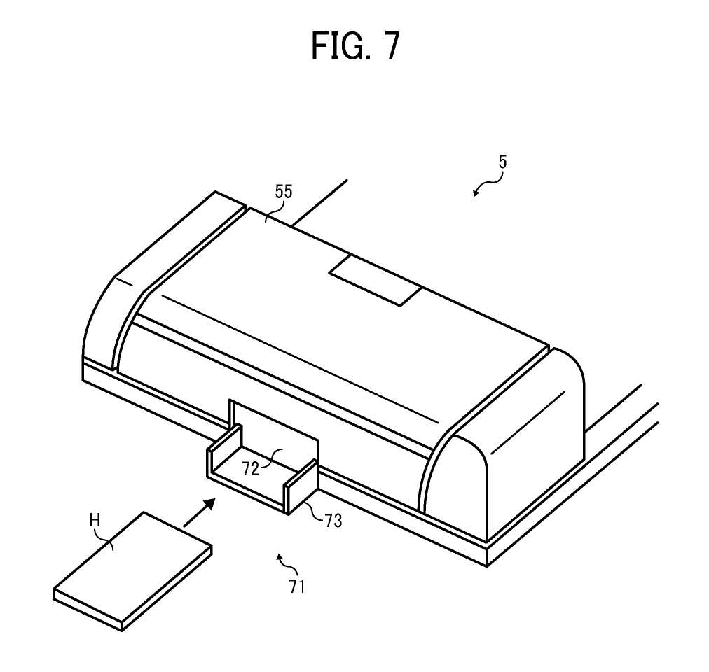

Further, when reading images on both sides of an original document in the DF scanner mode, both the first scanning unit 45 and the second scanning unit 68 perform scanning of the images. Specifically, the single unit optical scanning unit 47 of the first scanning unit 45 moves from a first document scanning position indicated by a solid line in FIG. 5 to a dotted line in FIG. 5 and the second scanning unit 68 that functions as a contact image sensor is disposed at a second document scanning position that is located at an upper side in inclination of the DF exposure glass 42 of the ADF 5 and a downstream side in a document conveying direction illustrated in FIGS. 3A, 3B, 3C, 5, and 6. The second scanning unit 68 scans an image formed on a back face side of the stationary original document S2 or the hard sheet H. After the image scanning is finished, the first scanning unit 45 returns to the flatbed scanning home position again.

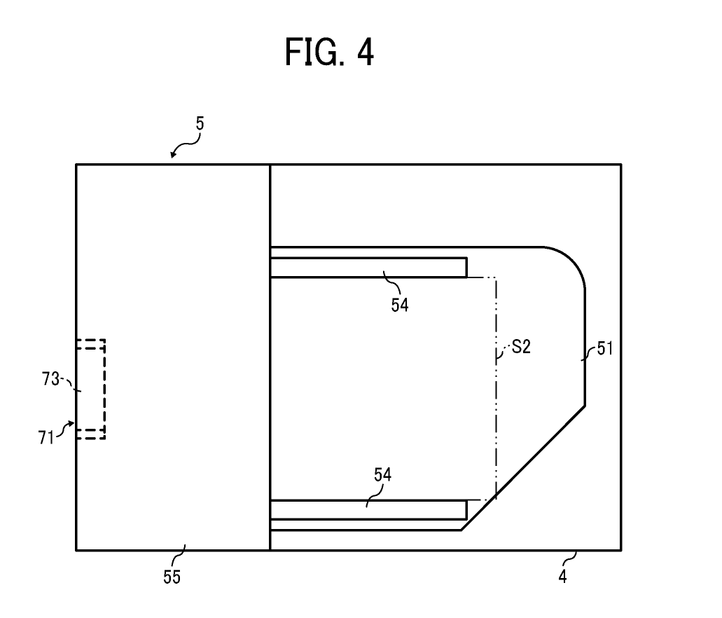

FIG. 4 is a schematic plan view illustrating the image forming apparatus 1 according to an embodiment of this disclosure.

As illustrated in FIGS. 3A, 3B, 3C, and 4, the ADF 5 includes the original document table 51, the original document conveying passage 52, and an original document output tray 53. The original document table 51 functions as an original document loading table on which a standard size sheet can be loaded. The original document conveying passage 52 functions as a sheet conveying passage through which an original document S passes between a document feeding port 55a (that functions as a first sheet supplying port) and a document discharging port 56. In the course of conveyance, the original document conveying passage 52 changes the direction of conveyance of the original document S at the U-turn side, so that the original document S passes by an image reading position on the DF exposure glass 42. The original document output tray 53 stacks the original document S after the image of the original document S is read and is output from the document discharging port 56.

It is to be noted that, in order to achieve a reduction in size, the original document table 51 and the original document output tray 53 are disposed vertically separated from each other as well as part of the original document table 51 and the original document output tray 53 are disposed vertically overlapping at least in a planar view.

As illustrated in FIG. 4, the original document table 51 includes a pair of side guide plates 54 to contact the mobile original document S1 loaded thereon at both sides in a sheet width direction that is perpendicular to the sheet feeding direction. The pair of side guide plates 54 is a center reference member to position the center in the width direction of the original document table 51. The pair of side guide plates 54 can contact and separate relative to the center reference so as to match the center in the width direction of the mobile original document S1 with the center in the width direction of the original document table 51.

It is to be noted that the pair of side guide plates 54 may be a side reference member to position a side face of an original document. In this case, one plate of the pair of side guide plates 54 is fixed so that one side of an original document can be positioned as a side reference and the other plate of the pair of side guide plates 54 is moved close to or away from the fixed plate of the pair of side guide plates 54.

As illustrated in FIG. 2, the ADF 5 includes a cover 55 that is disposed at a downstream side in the document feeding direction of the mobile original document S1 to cover the top and three sides of the mobile original document S1. When the cover 55 is removed, the inside of the ADF 5 is widely open for maintenance.

It is to be noted that the cover 55 may be disposed to cover at least the top of the mobile original document S1 at the downstream side in the document feeding direction. The cover 55 includes the document feeding port 55a relative to the original document table 51. The original document table 51 is designed such that a small part of the leading end of the mobile original document S loaded thereon is inserted and covered by the cover 55.

In addition, the ADF 5 has main guide portions in the original document conveying passage 52 from the document feeding port 55a to the document discharging port 56. The main guide portions of the ADF 5 are formed by ribs formed on an inner face of the cover 55.

FIG. 5 is a schematic front view illustrating the image reading device 4 in the DF scanner mode.

As illustrated in FIG. 5, the ADF 5 guides an uppermost original document S1 or multiple original documents S1 from a bundle of original documents S1 loaded on the original document table 51 to the document feeding port 55a. Then, a document separation unit 52a that functions as a document feeder disposed at a far side position from the document feeding port 55a separates from the bundle of original documents S1 and feeds the uppermost original document S1 into the original document conveying passage 52.

Multiple document conveying rollers 52b, 52c, and 52d are disposed in the original document conveying passage 52 of the ADF 5. As the mobile original document S1 travels through the original document conveying passage 52, the multiple document conveying rollers 52b, 52c, and 52d cause the mobile original document S1 to make a half U-turn to turn downwardly in the vertical direction. Then, the original document conveying passage 52 conveys the mobile original document S1 along the DF exposure glass 42 that straightly rises with a slope toward the document discharging port 56. The mobile original document S1 passes the predetermined scanning position (specific operation performing position) Pd1 located in the middle of the upper face of the DF exposure glass 42. When the mobile original document S1 passes over the DF exposure glass 42, the single unit optical scanning unit 47 illustrated in FIG. 3C performs line scanning repeatedly at the scanning position Pd1 to read the image of the mobile original document S1 while the mobile original document S1 is conveyed. Further, a pair of document output rollers 52e and 52f is disposed at the document discharging port 56 that is a conveying passage end position. After the image of the mobile original document S1 is read, the mobile original document S1 is conveyed in the original document conveying passage 52 and is output by the pair of document output rollers 52e and 52f onto the original document output tray 53.

It is to be noted that the number of rollers for sheet reversing and sheet discharging and the positions of the rollers can be freely determined according to setting conditions of the original document conveying passage 52 and the length in the document feeding direction of the smallest mobile original document S1.

When being located at the scanning position Pd1 as illustrated in FIG. 3C, the first scanning unit 45 can read an image formed on the mobile original document S1 that is passing over the DF exposure glass 42 by the single unit optical scanning unit 47. Then, the mobile original document S1 having the image read by the single unit optical scanning unit 47 is output onto the original document output tray 53 by the pair of document output rollers 52e and 52f.

The document separation unit 52a, the multiple document conveying rollers 52b, 52c, and 52d, and the pair of document output rollers 52e and 52f form a document conveying device 50. The document conveying device 50 further includes multiple sensors disposed along the original document conveying passage 52 and a controller that controls conveyance of original documents based on detection results obtained by the multiple sensors. The document conveying device 50 conveys the original document S from the original document table 51. At the same time, the document conveying device 50 reverses the original document S by making a turn in the original document conveying passage 52 so as to cause the original document S to pass the scanning position Pd1. Then, the document conveying device 50 discharges the original document S within a stacking area on the original document output tray 53 that is a document discharging area outside the original document table 51.

The multiple sensors disposed along the original document conveying passage 52 are, for example, known sheet proper position sensors, document contact sensors, reading entrance sensors, registration sensors, output sensors and so forth. These sensors are disposed serially from the upstream side to the downstream side along the sheet conveying direction. Certainly, the regular mobile original document S1 corresponds to a plain paper copy (PPC) sheet or other easily bendable sheet having an image recordable side.

Next, a description is given of a sheet supplying port 72 (that functions as a second sheet supporting port) and a straight conveying passage 61, with reference to FIGS. 2, 4, 6, and 7.

The ADF 5 includes a card supplying portion 71 to read an image formed on the hard sheet H such as a card that is not conveyed by reverse conveyance via a U-turn portion or a thick paper. The card supplying portion 71 includes the sheet supplying port 72, a card supplying tray 73, and a card pickup roller 74.

The card supplying tray 73 is generally in a closed state. In the closed state, the card supplying tray 73 functions as part of the sheet transfer guide of the original document S that is a regular original document that is conveyed through the U-turn portion and, at the same time, functions as part of the side face of the cover 55. By so doing, when the card supplying tray 73 is open outwardly, as illustrated in FIG. 7, the sheet supplying port 72 opens.

The original document conveying passage 52 is a straight conveying passage having one flat face of a sheet conveying passage that runs from a nip region formed by the document conveying rollers 52c and 52d, over an inclined upper face of the DF exposure glass 42, to the pair of document output rollers 52e and 52f. A card loading face of the card supplying tray 73 is arranged to be an extension face of an inclined face of the DF exposure glass 42 when the card supplying tray 73 is open outwardly. The straight conveying passage 61 includes the card loading face of the card supplying tray 73 and functions as a relatively short conveying passage from the sheet supplying port 72 toward the nip region of the document conveying rollers 52c and 52d. The straight conveying passage 61 merges into the original document conveying passage 52 at the nip region of the document conveying rollers 52c and 52d from a tangent line direction.

When a small size hard sheet H is set on the card loading face of the card supplying tray 73 and is inserted into the ADF 5, the card pickup roller 74 takes in the hard sheet H to feed the hard sheet H such as a card between the nip region of the document conveying rollers 52c and 52d. The original document conveying passage 52 is designed to cause the hard sheet H to pass a predetermined scanning position Pd1 on the DF exposure glass 42. As the hard sheet H is placed with an image formed on a contact side contacting the DF exposure glass 42, the single unit optical scanning unit 47 that stops at the lower part of the scanning position Pd1 scans the image on the contact side of the hard sheet H. Then, in the duplex scanning mode, the second scanning unit 68 scans an image formed on an upper face side (a back face side) of the hard sheet H as the hard sheet H is further conveyed. Thereafter, the hard sheet H is ejected by the pair of document output rollers 52e and 52f disposed at the document discharging port 56 onto the original document output tray 53.

Small size hard sheets H may be standard size cards formed by resin (or thick paper) such as driving license cards, ID cards (identification cards), and travel cards. Therefore, a small size card described herein corresponds to a card, for example, having a size of any one of ID-1, ID-2, and ID-3 of ISO/IEC7810 that is an international standard that regulates the shapes of an identification card or a card having the substantially same size as the above-described card. However, a width in the lateral direction of the small card is set to be smaller than a width in the lateral direction of the smallest size cut sheet of multiple standard cut sheet sizes that are settable on the original document table 51.

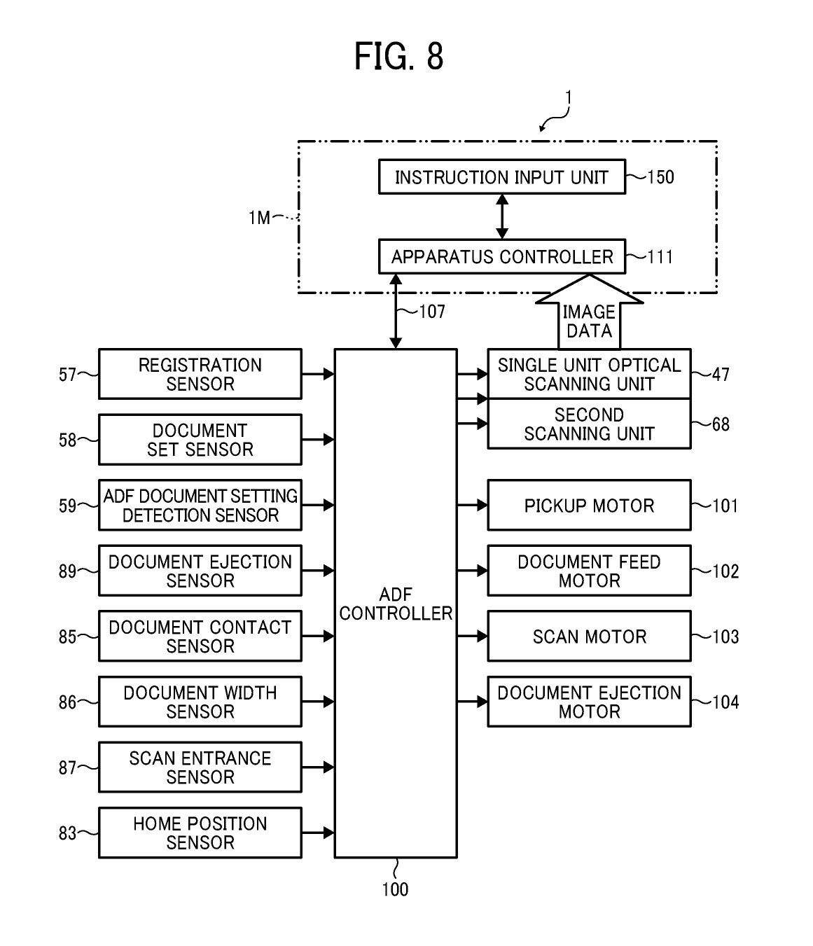

FIG. 8 is a block diagram illustrating an ADF controller 100 and an apparatus controller 111 and parts connected to the ADF controller 100 of the image forming apparatus of FIG. 1;

As illustrated in FIG. 8, the image forming apparatus 1 further includes the ADF controller 100, the apparatus controller 111, and an instruction input unit 150. The ADF controller 100 controls operations performed by the ADF 5. The apparatus controller 111 controls operations performed by the devices provided in the housing 1M. The instruction input unit 150 is mounted on the upper front side of the image forming apparatus 1 to receive instructions to be transmitted to the apparatus controller 111.

The ADF controller 100 and the apparatus controller 111 are connected via interface (I/F) 107.

As a print key of the instruction input unit 150 is pressed down, the apparatus controller 111 issues a document feeding signal to feed the mobile original document S1 or a reading start signal to start reading the image data of the stationary original document S2 and sends a selected signal of the document feeding signal and the reading start signal to the ADF controller 100 via the I/F 107.

The ADF controller 100 is connected to a document set sensor 58, an ADF document setting detection sensor 59, a registration sensor 57, a home position sensor 83, a document contact sensor 85, a document width sensor 86, a scan entrance sensor 87, and a document ejection sensor 89, as illustrated in FIG. 8. The ADF controller 100 receives various detection signals from these sensors.

The ADF controller 100 is also connected to a pickup motor 101, a document feed motor 102, a scan motor 103, and a document ejection motor 104. The pickup motor 101 drives to rotate the pickup roller of the document separation unit 52a. The document feed motor 102 drives to rotate the document conveying rollers 52b, 52c, and 52d. The scan motor 103 drives to rotate the timing pulley to move the bracket 48. The document ejection motor 104 drives to rotate the pair of document output rollers 52e and 52f.

Next, descriptions are given of an automatic coupling device 310 according to the present embodiment, with reference to FIGS. 9 through 11.

As illustrated in FIG. 9, the image forming apparatus 1 according to the present embodiment includes the sheet feeding device 2 contained in the housing 1M, the image forming device 3 including the developing devices, the transfer device, and the fixing device and contained in the housing 1M, the recording sheet output tray 303 that functions as a cover to open and close the opening portion of the upper face of the housing 1M, the image reading device 4, and the ADF 5.

The recording sheet output tray 303 may open and close together with opening and closing of the image reading device 4 or separately from opening and closing of the image reading device 4. The recording sheet output tray 303 according to the present embodiment of this disclosure employs the configuration to open and close together with opening and closing of the image reading device 4. Specifically, the recording sheet output tray 303 is rotatably coupled with a hinge shaft 321 at an upper part of the trailing end thereof. The hinge shaft 321 is a center of rotation of the image reading device 4 when opening and closing the image reading device 4. Further, the recording sheet output tray 303 is also coupled with a side face of the opening portion of the upper face of the housing 1M at a position closer from the coupling position with the hinge shaft 321 toward the front side of the image forming apparatus 1 by a relatively small distance via a coupling tool 327 that can cancel the coupling. Accordingly, in the present embodiment of this disclosure, the recording sheet output tray 303 opens and closes together with opening and closing of the image reading device 4. Consequently, the configuration of the recording sheet output tray 303 in the present embodiment of this disclosure is more convenient than the configuration in which the recording sheet output tray 303 opens and closes separately from opening and closing of the image reading device 4.

The image reading device 4 is coupled with the housing 1M at the rear end of the image forming apparatus 1 to rotate about the hinge shaft 321 as the center of rotation via the first hinge 320. The image reading device 4 is disposed switchable (openable and closable) between an overlapping state in which the image reading device 4 overlaps the recording sheet output tray 303 and an open state (in other words, a standing state) in which the image reading device 4 stands upwardly to be opened by an angle sufficient for a user to remove consumable supplies such as a photoconductor and a tonner bottle, preferably to open at an angle of approximately 90 degrees relative to the housing 1M toward the rear end of the image forming apparatus 1.

Further, the ADF 5 is coupled with the image reading device 4 at the rear end of the image forming apparatus 1 via the second hinge 323. The ADF 5 is disposed openable and closable between an overlapping state in which the ADF 5 is closed on the image reading device 4 and a standing state in which the ADF 5 is opened and standing upwardly relative to the image reading device 4 toward the rear end of the image forming apparatus 1.

Accordingly, when setting the stationary original document S2 on the flatbed exposure glass of the image reading device 4, the ADF 5 is opened and closed relative to the image reading device 4. Further, when replacing toner tanks or performing other maintenance with the opening portion of the upper face of the recording sheet output tray 303 left open, the image reading device 4 is opened by approximately 90 degrees toward the rear end of the image forming apparatus 1 from a state in which the image reading device 4 is closed and the ADF 5 is closed on the image reading device 4. By so doing, the ADF 5 is opened while being closed on the image reading device 4 and the recording sheet output tray 303 is also opened by approximately 90 degrees, as illustrated in FIG. 11.

In this case, if a user opens the image reading device 4 with great force, the ADF 5 may separate from the image reading device 4 and further open by approximately 90 degrees to fall toward the rear side of the image forming apparatus 1 to a horizontal level. Therefore, the image forming apparatus 1 further includes an automatic coupling device 310 so that the ADF 5 remains overlapping to be closed on the image reading device 4 even when the user opens the image reading device 4 with great force. Details of the automatic coupling device 310 are described below.

The automatic coupling device 310 is disposed across the image reading device 4 and the ADF 5. The automatic coupling device 310 is designed to couple the ADF 5, the image reading device 4, and the cover 55 with each other integrally when the image reading device 4 is opened in a state in which the ADF 5 is disposed overlapping and closed on the image reading device 4.

Specifically, the ADF 5 has a lower portion 5a where the mobile original document S1 is reversed. The lower portion 5a of the ADF 5 extends downwardly from an upper body of the ADF 5 to cover a side face 4a of the image reading device 4 on a side of the DF exposure glass 42. An extension member 302 is disposed between the lower portion 5a of the ADF 5 and the upper face of the housing 1M, at which the mobile original document S1 is reversed. The extension member 302 extends from a lower face 4b of the image reading device 4. The automatic coupling device 310 is disposed over the extension member 302 and the lower portion 5a of the ADF 5.

The automatic coupling device 310 includes a hook member 313, a tension spring 318, and an engaging recess 317. The hook member 313 and the tension spring 318 are disposed inside a through hole 311 that vertically penetrates the extension member 302 at a position closer to the front end of the image forming apparatus 1 (i.e., the front end of the extension member 302) from the rear end of the image forming apparatus 1 (i.e., the rear end of the extension body 302). The engaging recess 317 is provided at the lower portion 5a of the ADF 5.

The hook member 313 that functions as a hook body is rotatably supported by a wall of the through hole 311 of the extension member 302. A pin shaft 312 is inserted into an opening formed on the middle the hook member 313 to rotate about the pin shaft 312. The hook member 313 includes a hook portion 315 at an upper end thereof and a contact portion 314 at a lower end thereof. One end of the tension spring 318 is retained at the sidewall of the through hole 311 of the extension member 302 and an opposed end of the tension spring 318 is retained at a position higher than the pin shaft 312 inserted into the middle portion of the hook member 313. The hook portion 315 is located in a recess 316 mounted on the lower portion 5a of the ADF 5.

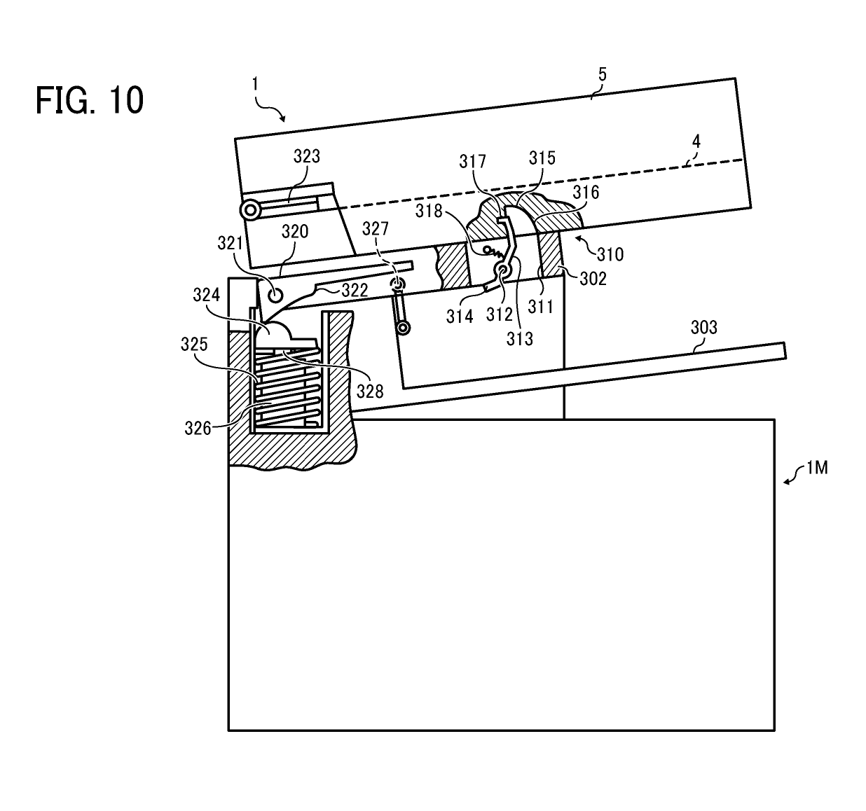

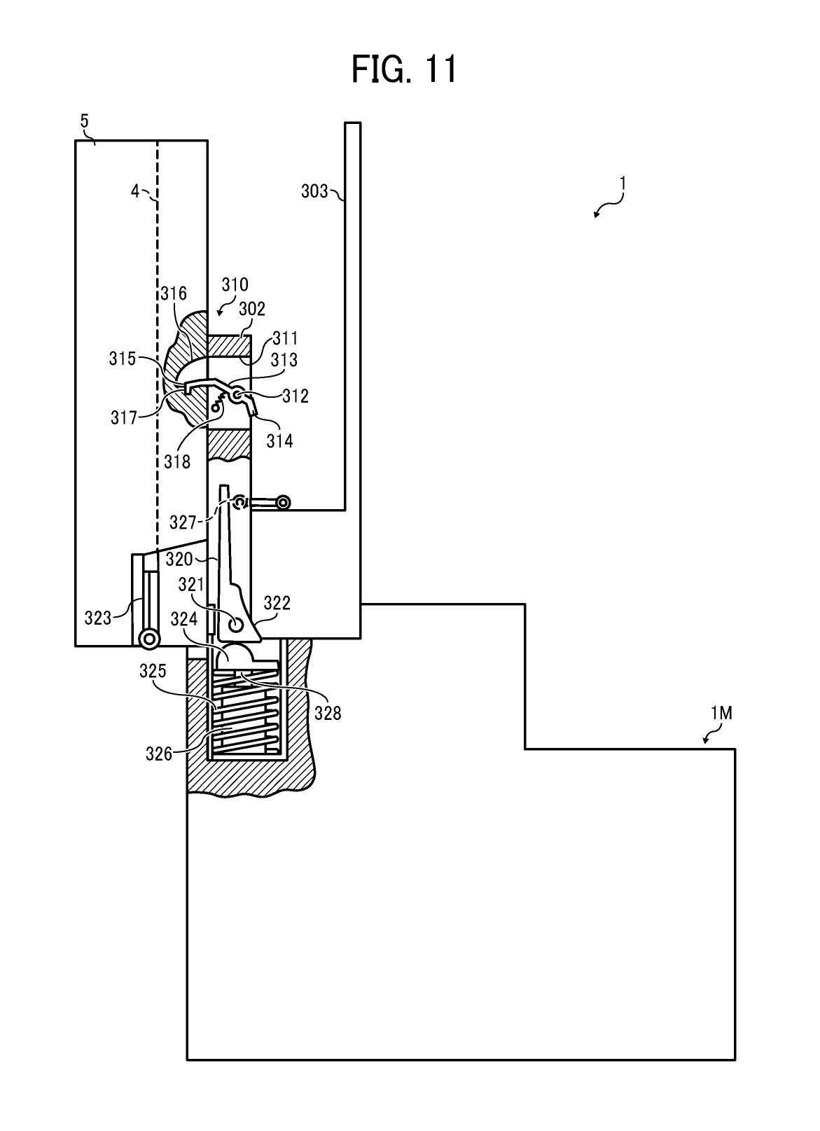

As illustrated in FIG. 9, when the image reading device 4 overlaps to be closed on the housing 1M, the contact portion 314 of the hook member 313 contacts the upper face of the housing 1M in an inclined attitude and the hook portion 315 is disengaged from the engaging recess 317 formed in the ADF 5 to be in a non-coupled state. Further, as illustrated in FIG. 10, when the image reading device 4 is opened and separated from the housing 1M, the contact portion 314 of the hook member 313 separates from the housing 1M in a standing attitude due to a biasing force exerted by the tension spring 318 and the hook portion 315 is engaged with the engaging recess 317 formed in the ADF 5, so that the image reading device 4 and the ADF 5 are in a coupled state.

Consequently, when a stationary original document S2 is placed on the flatbed exposure glass 41 of the image reading device 4, the automatic coupling device 310 is in a released state of the coupling, and therefore the ADF 5 is opened and closed relative to the image reading device 4. Further, when the opening portion of the upper face of the housing 1M is opened, the automatic coupling device 310 is automatically switched from the released state to the coupled state along with opening of the image reading device 4. Consequently, as illustrated in FIG. 11, the image reading device 4 and the ADF 5 gradually open with the ADF 5 closed on the image reading device 4. When the coupling tool 327 is in the coupled state, the recording sheet output tray 303 opens and closes together with the image reading device 4. By contrast, when the coupling tool 327 is in the non-coupled state, the recording sheet output tray 303 opens and closes individually while being separated from the image reading device 4.

As illustrated in FIG. 9, the image forming apparatus 1 according to the present embodiment of this disclosure includes a compression spring 325 and a fluid pressure damper 326. The compression spring 325 affects on the first hinge 320, so that a load of the compression spring 325 gradually increases as the image reading device 4 is opened, and the load of the compression spring 325 gradually decreases as the image reading device 4 is closed. The fluid pressure damper 326 increases a load thereof immediately before the image reading device 4 overlaps to be closed on the housing 1M and reduces a speed of closing the image reading device 4. In other words, the fluid pressure damper 326 generates a resistance (a load) in contact with in a period from a time immediately before the image reading device is closed on the housing to a time the image reading device is closed on the housing.

The first hinge 320 is integrally provided with the extension member 302. The first hinge 320 has a first cam 322 to act on the compression spring 325 and the fluid pressure damper 326. A second cam 324 is disposed between the first cam 322 and a piston 328 of the fluid pressure damper 326 and remains in contact with the first cam 322. Due to correlation of the compression spring 325, the first cam 322, and the second cam 324, a load (i.e., a resistance) of the first hinge 320 gradually increases when the image reading device 4 is opened, and the load (the resistance) of the first hinge 320 gradually decreases when the image reading device 4 is closed. Accordingly, this correlation gives a user to prevent the user from opening the ADF 5, the image reading device 4, and the recording sheet output tray 303 with great force. Further, as the first cam 322 of the first hinge 320 in contact with the second cam 324 presses down the second cam 324, the second cam 324 starts pressing down the piston 328 of the fluid pressure damper 326 immediately before the image reading device 4 overlaps to be closed on the housing 1M. This configuration increases the load (the resistance) applied to the image reading device 4, so that the closed speed of the image reading device 4 is decreased. Accordingly, this configuration prevents that a user closes the ADF 5, the image reading device 4, and the recording sheet output tray 303 with great force.

In a case in which known image forming apparatuses achieve coupling and uncoupling an ADF, an image reading device, and a cover with a coupling device, a user performs respective switching operations for coupling and uncoupling the ADF and the image reading device and coupling and uncoupling the image reading device and the cover. In addition, such known image forming apparatuses include a relatively large number of parts and components provided in a relatively large space inside a housing of each known image forming apparatus in a front-to-rear direction of the housing. Further, a large amount of time is taken for assembling. As a result, the total cost of the known image forming apparatus increases.

In addition, the coupling locking device cannot be employed to an image forming apparatus of a different model from the above-described known image forming apparatus, specifically, an image forming apparatus in which a lower part of the housing at a document reversing side of the automatic document feeder is disposed covering the side face of the image reading device.

By contrast, in the image forming apparatus 1 according to the present embodiment of this disclosure, a coupling retaining operation is not provided but the automatic coupling device 310 is provided to perform coupling of the ADF 5 and the image reading device 4 at an instant the image reading device 4 is opened and lifted, regardless of an opening speed of the image reading device 4. Therefore, even when the ADF 5 and the image reading device 4 open together with great force, it is not likely that the ADF 5 falls toward the rear side of the image forming apparatus 1 to the horizontal level. Simultaneously, the recording sheet output tray 303 is also opened. Accordingly, this configuration prevents overturning of the image forming apparatus 1 at replacement of consumable supplies such as toner bottles. In addition, even though an empty space is not secured at the rear side of the image forming apparatus 1, the upper face of the housing 1M is opened without any trouble, and therefore maintenance such as replacement of toner bottles or other consumable supplies. Further, when compared with known image forming apparatuses, the image forming apparatus 1 according to the present embodiment of this disclosure is provided with a smaller number of parts and components. Therefore, these parts and components can be contained in a smaller space, thereby having good assembling performance and significantly reducing manufacturing costs of the image forming apparatus 1. Further, when compared with known image forming apparatuses, the image forming apparatus 1 according to the present embodiment of this disclosure has a smaller number of parts and components of the automatic coupling device 310, therefore has good assembling performance and significantly reduces manufacturing costs of the automatic coupling device 310.

According to this disclosure, even if a user opens the automatic document feeder and the image forming device with great force, it is not likely that the automatic document feeder does not fall toward the rear side of the image forming apparatus to the horizontal level. Therefore, this disclosure achieves effects in which the image forming apparatus is not overturned when the consumable supplies such as toner are replaced and no empty space is to be secured at the rear side of the image forming apparatus. Accordingly, this disclosure is applicable to any image forming apparatus having functions to turning an automatic document feeder, an image forming device, and a cover that opens and closes an opening of an upper face of a housing of the image forming apparatus upwardly toward the rear side of the image forming apparatus.

The above-described embodiments are illustrative and do not limit this disclosure. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of this disclosure may be practiced otherwise than as specifically described herein.

What is claimed is:

1. An image forming apparatus comprising:
a housing;
an image forming device housed in the housing;
an image reading device coupled with the housing at a rear end of the housing via a first hinge and switchable between an overlapping state overlapping the housing and a standing state standing at the rear end of the housing, the image reading device configured to read an image on an original document;
an automatic document feeder disposed coupled with the image reading device at a rear end of the image reading device via a second hinge and switchable between an overlapping state overlapping the image reading device and a standing state standing at the rear end of the image reading device, the automatic document feeder configured to turn the original document and convey the original document to an image position; and
an automatic coupling device disposed across the image reading device and the automatic document feeder and configured to couple the automatic document feeder and the image reading device with each other when the image reading device is opened in a state in which the automatic document feeder is overlapped on the image reading device.

2. The image forming apparatus according to claim 1, further comprising an extension body,
wherein the automatic document feeder includes a lower portion where the original document is reversed,
wherein the image reading device includes a side face and a lower face where the original document is reversed,
wherein the lower portion extends downwardly and configured to cover the side face of the image reading device,
wherein the extension body is disposed between the lower portion of the automatic document feeder and an upper face of the housing, extending from the lower face of the image reading device, and
wherein the automatic coupling device is disposed over the extension body and the lower portion of the automatic document.

3. The image forming apparatus according to claim 1, further comprising an extension body disposed between a lower portion of the automatic document feeder and an upper face of the housing, extending from a lower face of the image reading device,
wherein the automatic coupling device comprises:
a hook body disposed vertically extending at a position closer to a front end of the extension body from a rear end of the extension body, the hook body fixedly supported by a pin shaft at a middle and including a hook portion at an upper end and a contact portion at a lower end;
a tension spring having one end retained at the extension body and an opposed end retained at a position higher than the pin shaft at the middle of the hook body; and
an engaging recess formed in the automatic document feeder,
wherein, when the image reading device overlaps the housing, the hook body is in a non-coupled state in which the contact portion of the hook body contacts the housing in an inclined attitude and the hook portion is disengaged from the engaging recess, and
wherein, when the image reading device is opened from the housing, the hook body is in a coupled state in which the contact portion of the hook body separates from the housing in a standing attitude due to a biasing force exerted by the tension spring and the hook portion is engaged with the engaging recess.

4. The image forming apparatus according to claim 1, further comprising a cover configured to open and close an opening portion of an upper face of the housing, together with the image reading device integrally.

5. The image forming apparatus according to claim 4,
wherein the cover includes a recording medium output tray.

6. The image forming apparatus according to claim 1,
wherein the first hinge comprises:
a compression spring;
a cam configured to engage with the compression spring; and
a fluid pressure damper configured to generate a resistance via a piston in contact with the cam in a period from a time immediately before the image reading device is closed on the housing to a time the image reading device is closed on the housing.
